(19) United States
(12) Patent Application Publication
(10) Pub. No.: US 2026/0043920 A1
(43) Pub. Date: Feb. 12, 2026

(54) Method for Operating an Analog-Digital Converter in a Laser System

(71) Applicant: Robert Bosch GmbH, Stuttgart (DE)

(72) Inventors: Joern Hoffarth, Reutlingen (DE); Stefan Noe, Stuttgart (DE); David Copeto, Ludwigsburg (DE)

(21) Appl. No.: 19/289,271

(22) Filed: Aug. 4, 2025

(30) Foreign Application Priority Data
Aug. 7, 2024 (DE) 10 2024 207 466.7

(51) Int. Cl. G01S 17/14

(52) U.S. Cl. CPC G01S 17/14

(57) ABSTRACT

A method for operating an analog-digital converter in a laser system includes (i) initiating operation of the laser system in a pulsed laser operation, wherein, in the pulsed laser operation, light is emitted by the laser system only during defined time periods, (ii) enabling the operation of the analog-digital converter of the laser system during the defined time periods of the pulsed laser operation in which light is emitted by the laser system, and (iii) blocking the operation of the analog-digital converter during time periods of the pulsed laser operation, in which no light is emitted by the laser system. A computer program, an apparatus, and a storage medium for this purpose are also disclosed.

This application claims priority under 35 U.S.C. § 119 to application no. DE 10 2024 207 466.7, filed on Aug. 7, 2024 in Germany, the disclosure of which is incorporated herein by reference in its entirety.

The disclosure relates to a method for operating an analog-digital converter in a laser system. The disclosure further relates to a computer program, an apparatus, and a storage medium for this purpose.

### BACKGROUND

Modern laser applications used in numerous fields such as industry, medicine, communication and research require highly precise control and monitoring of the laser parameters. Analog signals originating from various sensors within the laser system must be converted into digital data in order to be processed by the control electronics. The use of analog-digital converters allows these analog readings to be converted into digital signals in real time and with high accuracy, thereby ensuring precise control of laser power, temperature and other critical parameters.

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the apparatus according to the disclosure, and the computer-readable storage medium according to the disclosure, and vice versa in each case, so that a reciprocal reference is always possible with regard to the disclosure of the disclosure.

The object of the disclosure is in particular a method for operation, in particular targeted operation, of an analog-digital converter in a laser system, comprising the following steps, wherein the steps can be repeated and/or performed sequentially or in a particular order. In particular, the laser system is a laser rangefinder. Targeted operation relates in particular to time-targeted operation, i.e., operation during certain time periods, by the analog-digital converter. In particular, the analog-digital converter converts analog signals received from a detector of the laser system into digital signals.

In a first step, preferably an operation of the laser system in a pulsed laser operation is initiated, wherein, in the pulsed laser operation, light is emitted by the laser system only during defined time periods (called “bursts”). In other words, in particular, time-limited light pulses are emitted by a laser of the laser system. This may advantageously reduce average laser power, which is relevant, for example, with regard to a hazard to the eyes of a user. At the same time, the laser power emitted during the light pulses may be increased, which may lead to an improvement of the signal to noise ratio. For example, the defined time periods may be in the millisecond range.

In a further step, preferably the operation of the analog-digital converter of the laser system is enabled during the defined time periods of the pulsed laser operation in which light is emitted by the laser system. In other words, a conversion mode of the analog-digital converter is activated, in which the analog-digital converter is operated for converting analog signals into digital signals. Thus, advantageously a measurement by the laser system may be reduced to the defined time periods of the pulsed laser operation in which advantageously a higher laser power may be used than in a continuous mode of the laser system. Thus, advantageously, the signal received by the analog-digital converter may be increased.

In a further step, preferably the operation of the analog-digital converter is blocked during time periods of pulsed laser operation, in which no light is emitted by the laser system. Thus, advantageously, it can be ensured that the analog-digital converter does not receive an irrelevant signal with respect to measurement by the laser system and thus the required dynamic range of the analog-digital converter is reduced, which can save costs and energy.

One advantage resulting from the method according to the disclosure is that the dynamic range that the analog-digital converter must provide is significantly smaller. Laser systems with a pulse power of 5 mW, for example, are conceivable. With the method according to the present disclosure, a 14-bit resolution of the analog-digital converter can be distributed between 4 and 6 mW when sizing the electronics. Without the disclosure, for example, the resolution would have to be distributed from 0 to 6 mW. In addition to the advantages for the analog-digital converter, a complexity of the filters and the settling time of the filters can also be greatly reduced. For example, if a low-pass filter of the first magnitude with a cut-off frequency equal to the burst period of 1 ms were selected, there would particularly be a residual ripple of half a signal despite the filtering. Thus, for example, one would have to at least reduce the cut-off frequency by a factor of 20, that is 20 ms or 50 Hz. Until such a filter is charged to 95%, switching on the laser would take in particular 60 ms. With the method according to the disclosure, in particular, only 5 ms would be used here.

In addition, it is contemplated within the scope of the disclosure that the defined time periods are shorter than a conversion rate of the analog-digital converter. In this case, the method according to the present disclosure may be particularly advantageous, as otherwise a decrease in resolution of the analog-digital converter may occur.

In addition, the light emitted by the laser system in the pulsed laser operation may be intensity modulated by the laser system, particularly at different frequencies. Intensity modulation is particularly advantageous when the laser system is configured as a laser rangefinder.

Preferably, the disclosure may provide that the method further comprises the following step:
defining a delay period.
   Enabling of the operation can then be offset by the defined delay period. In other words, the operation by the analog-digital converter is preferably performed during a respective light pulse, i.e., during a respective defined time period in which light is emitted by the laser system, only after the defined delay time period has elapsed. Thus, advantageously, errors or particular characteristic features that occur when the laser is switched on may be disregarded during the operation.

According to a further possibility, it can be provided that the method further comprises the following step:
determining a settling time and/or an overshoot time of a laser of the laser system when switching on the laser.
   The delay period may then be defined taking into account the determined settling time and/or overshoot time. In particular, the delay period may correspond to the value of the determined settling time and/or overshoot time of the laser, which, if necessary, may additionally be supplemented with a buffer value. Thus, advantageously, the initial settling and/or overshooting of the laser, which may result in distorted values, may be omitted.

Furthermore, it is optionally possible in the context of the disclosure that the determination of the average settling time and/or overshoot time takes place by way of a power measuring device over at least two periods of the pulsed laser operation. For example, the power measuring device may be a laser power meter. The power measuring device may further use a filter. In particular, if the settling time is to be determined for the delay period, a very fast laser power meter is required. For example, if the laser power is to be near a legal laser class limit, it may be useful to use a laser power meter that is more than 250 ms on average. In particular, a period of pulsed laser operation corresponds to a respective defined time period, during which light is emitted by the laser system. In other words, a period particularly comprises a time from one laser pulse to the next, including the dark period. By way of averaging, advantageously statistical errors can be balanced out.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution. The device may also be an analog discrete electronic circuit or an integrated electronic circuit configured to perform the method according to the disclosure.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a device, a storage medium, and a computer program according to exemplary embodiments of the disclosure,

FIG. 2 a schematic illustration of a laser system according to exemplary embodiments of the disclosure.

### DETAILED DESCRIPTION

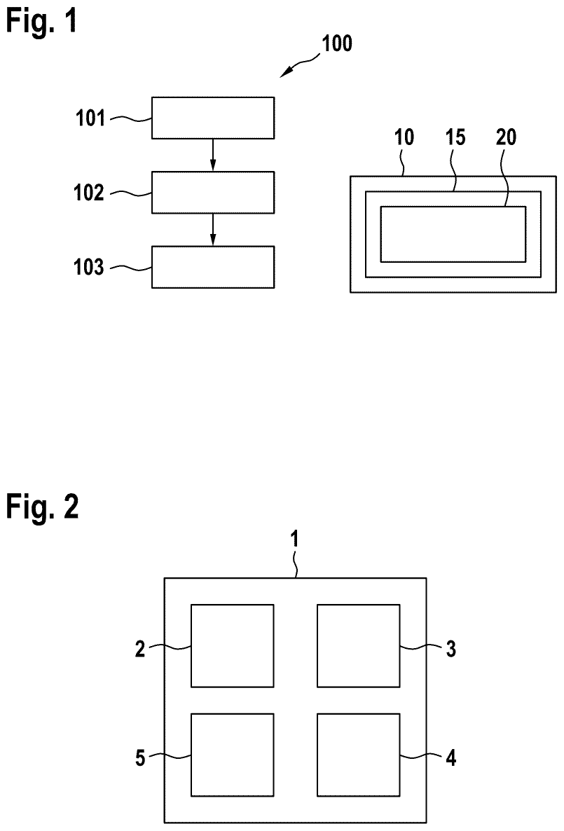

FIG. 1 schematically illustrates a method 100, a device 10, a storage medium 15, and a computer program 20 according to exemplary embodiments of the disclosure.

In particular, FIG. 1 shows an exemplary embodiment for a method 100 for operating an analog-digital converter 2 in a laser system 1. In a first step 101, operation of the laser system 1 in a pulsed laser operation is initiated, wherein, in the pulsed laser operation, light is emitted by the laser system 1 only during defined time periods. In a second step 102, operation of the analog-digital converter 2 of the laser system 1 is enabled during the defined time periods of the pulsed laser operation in which light is emitted by the laser system 1. In a third step 103, operation of the analog-digital converter 2 is blocked during time periods of the pulsed laser operation, in which no light is emitted by the laser system 1.

The method of the present disclosure relates to a laser system 1, and according to exemplary embodiments, in particular to a laser rangefinder that uses the indirect Time of Flight (iToF) measurement method. For this exemplary embodiment, reference is made to FIG. 2. For example, this laser rangefinder 1 operates by measuring a phase shift of a modulated light signal emitted by the laser rangefinder and reflected by a target object. The following is a description of how the Indirect Time of Flight (iToF) measurement works. First, a laser 3 in the laser rangefinder 1 can transmit intensity-modulated light, for example in the infrared or visible area, towards a target object. The modulation is in particular carried out with a sinusoidal or square wave. The intensity-modulated light subsequently strikes the target object and is reflected back to the laser rangefinder 1. A detector 4 in the measuring device can now receive the reflected light. Since the light takes a certain amount of time to travel the distance, there is a phase shift between the transmitted signal and the received signal. This phase shift between the transmitted signal and the received signal may then be measured. This phase shift is in particular proportional to the distance of the light traveled. The distance may then be calculated from the phase shift taking into account the wavelength of the modulation and the speed of light. It may further be provided that a reference phase is determined with a constant distance to determine the phase shift based on a comparison to the reference phase.

The laser rangefinder 1 may comprise a measurement controller 5. The measurement controller 5 in particular assumes control of the laser 3.

Thus, the measurement controller 5 may control an emission of the laser 3 by controlling switching the power on and off, as well as controlling intensity and modulation of a laser beam of the laser 3. This can ensure that the laser beam is transmitted at the correct power and with the correct characteristics.

Furthermore, a laser beam of the laser system 1 may be modulated, for example in the form of pulsed light and/or a continuous wave of variable modulation frequency. The modulation in the form of the pulsed light corresponds in particular to the pulsed laser operation according to the present disclosure. After receipt of a portion of the emitted laser light by the detector 4, the received signal may be processed. This includes, for example, amplification, filtering and conversion of the received analog signal into a digital signal for further analysis, in particular by an analog-digital converter (not shown). Furthermore, the phase shift between the transmitted signal and the received signal may be measured and optionally compared to the reference phase.

The measurement controller 5 may also periodically perform calibrations to ensure that the measurements are precise. For this purpose, it can monitor a state of the laser 3 and the detector 4 to ensure that they are functioning properly.

In addition, the laser system 1, in particular the laser rangefinder, can comprise an analog-digital converter 2. The analog-digital converter 2 preferably converts analog signals received from the detector 4 into digital signals. In particular, these signals represent an emitted intensity of light transmitted by the laser 3. The digital conversion may allow the phase shift between the transmitted signal and the received signal to be analyzed. The digital signals provided by the analog-digital converter 2 may be further filtered, amplified, and processed to reduce noise and improve signal quality.

A signal from a burst timer of a measurement state machine of the laser system 1 preferably enables the operation of the analog-digital converter 2. When the light pulse is finished, the entire analog-digital converter 2 is preferably blocked or stopped. At the next light pulse of the pulsed laser operation, the analog-digital converter 2 preferably continues its work again. The measurement state machine is in particular a model that can be used to control and manage measurement processes. It is based in particular on the concept of a state machine that defines different states and transitions between these states. For example, these states represent different phases or steps in the measurement process.

By defining the delay period, advantageously the settling and/or overshoot of the laser 3 may be excluded from the change window of the analog-digital converter 2. Accordingly, the analog-digital converter 2 preferably only starts when the laser 3 is stable again. By assuming that the settling time and overshoot amount are consistent across temperatures and with aging, they may be disregarded. The settling time and/or overshoot amount may be recorded using averaging. For the regulation of the emitted laser power, a strongly filtering laser power meter can be used, which averages several periods of the pulsed laser operation of the laser system 1.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating an analog-digital converter in a laser system, comprising:
initiating operation of the laser system in a pulsed laser operation, wherein, in the pulsed laser operation, light is emitted by the laser system only during defined time periods;
enabling the operation of the analog-digital converter of the laser system during the defined time periods of the pulsed laser operation in which light is emitted by the laser system; and
blocking the operation of the analog-digital converter during time periods of the pulsed laser operation, in which no light is emitted by the laser system.

2. The method according to claim 1, wherein the analog-digital converter is configured to convert analog signals received from a detector of the laser system into digital signals and the defined time periods are shorter than a conversion rate of the analog-digital converter.

3. The method according to claim 1, wherein the light emitted by the laser system in the pulsed laser operation is intensity modulated by the laser system.

4. The method according to claim 1, further comprising:
defining a delay period, wherein each enabling of the operation is offset by the defined delay period.

5. The method according to claim 4, further comprising:
determining a settling time and/or an overshoot time of a laser of the laser system when switching on the laser, wherein the delay period is defined taking into account the determined settling time and/or overshoot time.

6. The method according to claim 5, wherein the determination of the average settling time and/or overshoot time takes place by way of a power measuring device over at least two periods of the pulsed laser operation.

7. The method according to claim 1, wherein the laser system is a laser rangefinder.

8. A computer program, comprising instructions that, when the computer program is executed by a computer, cause the computer to carry out the method according to claim 1.

9. A device for data processing, configured to carry out the method according to claim 1.

10. A computer-readable storage medium, comprising instructions which, when executed by a computer, cause it to carry out the steps of the method according to claim 1.
